(19) United States
(12) Patent Application Publication
(10) Pub. No.: US 2016/0289532 A1
(43) Pub. Date: Oct. 6, 2016

(54) FLUORINATED CARBON DIOXIDE SWELLABLE POLYMERS AND METHOD OF USE

(71) Applicant: HALLIBURTON ENERGY SERVICES, INC., Houston, TX (US)

(72) Inventors: Ramesh MUTHUSAMY, Pune, Maharashtra (IN); Sandip Prabhakar PATIL, Pune, Maharashtra (IN); Rahul Chandrakant PATIL, Pune, Maharashtra (IN); Vaishali MISHRA, Pune, Maharashtra (IN)

(21) Appl. No.: 15/037,295

(22) PCT Filed: Feb. 20, 2014
(86) PCT No.: PCT/US2014/017417

§ 371 Date: May 17, 2016

(51) Int. Cl. C09K 8/467; E21B 33/14; C04B 20/00

(52) U.S. Cl. CPC C09K 8/467; C04B 20/0024; E21B 33/14

(57) ABSTRACT

A cementing composition which is capable of self-sealing cracks in the cement composition is provided. For example, the composition includes a polymer that is swellable in the presence of gaseous hydrocarbons, hydrogen sulfide, carbon dioxide, carbonic acid and/or hydrochloric acid. A method for using the cementing composition in cementing operations for wellbore through a subterranean formation is also provided.

### FIELD

The present invention relates to cementing operations and, more particularly, in certain embodiments, to methods and compositions that provide for a set cement composition, which self-seal cracks.

### BACKGROUND

In the drilling and completion of oil and gas wells, it is common to place a cement slurry in the annulus between the wellbore and the casing. The set cement supports the casing and isolates the various subterranean zones through which the well passes. The zonal isolation prevents the migration of fluids from one formation to another. For effective zonal isolation, the cement must be a continuous sheath that does not allow any leakage.

Sometimes, the set cement forms cracks due to physical stresses caused by change in pressure or temperature, chemical attack, formation creep and other reasons. One approach for sealing the cracks is the incorporation of swellable materials in the cement composition. Ideally, the swellable materials would swell in the presence of gases, and fluids comprising dissolved gases, present in subterranean hydrocarbon reservoirs such as hydrocarbon gases, hydrogen sulfide, carbon dioxide, carbonic acid and hydrochloric acid; thereby blocking the migration of fluids and gases. Unfortunately, most of such swellable materials swell when they come in contact with liquids such as oil and water but they do not swell in gases such as hydrocarbons, hydrogen sulfide, carbon dioxide, carbonic acid and hydrochloric acid. Additionally, commercially available fluorinated polymers dissolve in carbon dioxide and also require high temperatures greater than at least 50° C. (122° F.) and pressure over 500 bar (approximately 7251 psi), Accordingly, such carbon dioxide soluble polymers are not well suitable for use as swelling material in downhole cementing operations.

### BRIEF DESCRIPTION OF THE DRAWINGS

FIG. 1 is a schematic representation of the polymer synthesis of Example 1.

### DESCRIPTION OF SPECIFIC EMBODIMENTS

The present description relates to well cement compositions and methods of sealing cracks in the set cement composition. Generally, the cracks result from physical and thermal stresses. An embodiment of the present cement compositions can comprise hydraulic cement, a polymer, and water. Those of ordinary skill in the art will appreciate that embodiments of the cement compositions generally should have a density suitable for a particular application. By way of example, the cement compositions may have a density in the range of from about 4 pounds per gallon (“ppg”) to about 24 ppg (about 479 kg/m³ to about 2874 kg/m³). In certain embodiments, the cement compositions may have a density in the range of from about 8 ppg to about 20 ppg (about 959 kg/m³ to about 2369 kg/m³). Embodiments of the cement compositions may be foamed or unfoamed or may comprise other means to reduce their densities, such as hollow microspheres, low-density beads, or other density-reducing additives known in the art. Those of ordinary skill in the art, with the benefit of this disclosure, will recognize the appropriate density for a particular application.

Embodiments of the cement compositions of the present invention may comprise hydraulic cement. Any of a variety of hydraulic cements suitable for use in subterranean cementing operations may be used in accordance with embodiments of the present invention. Suitable examples include hydraulic cements that comprise calcium, aluminum, silicon, oxygen and/or sulfur, which set and harden by reaction with water. Such hydraulic cements include, but are not limited to, Portland cements, pozzolan cements, gypsum cements, high-alumina-content cements, slag cements, and combinations thereof. In certain embodiments, the hydraulic cement may comprise a Portland cement. Portland cements that may be suited for use in embodiments of the present invention may be classified as Class A, C, H and G cements according to American Petroleum Institute, API Specification for Materials and Testing for Well Cements, API Specification 10, Fifth Ed., Jul. 1, 1990. In addition, in some embodiments, hydraulic cements suitable for use in the present invention may be classified as ASTM Type I, II, or III.

Polymers may also be present in embodiments of the cement compositions of the present invention. Generally, the polymers useful in such embodiments will be ones that swell in the presence of gaseous hydrocarbons (such as methane, ethane and natural gas, which are non-limiting examples), hydrogen sulfide, carbon dioxide, carbonic acid and/or hydrochloric acid. By “swell,” “swelling” or “swellable” it is meant that the polymer increases its volume upon exposure to gaseous hydrocarbon, hydrogen sulfide, carbon dioxide, carbonic acid and/or hydrochloric acid, typically such that the resulting volume is greater than would be expected by mere linear addition of the polymer volume and the volume of gaseous hydrocarbon, hydrogen sulfide and/or carbon dioxide. Often the swelling can result in at least a 5% increase in the polymer volume and can result in at least a 10% increase, at least a 13% increase, or at least a 20% increase in the polymer volume. Preferably, the polymer will be a carbon dioxide swellable polymer meaning that it at least swells upon exposure to carbon dioxide but can also swell upon exposure to hydrocarbons, hydrogen sulfide, carbonic acid and/or hydrochloric acid.

The polymers currently considered to be most useful in the invention are carbon dioxide swellable polymers that are swellable in carbon dioxide at a temperature below 250° C. and at a pressure below 1000 bar. Generally, useful polymers can be swellable in carbon dioxide at temperatures below 200° C., below 150° C. or below 100° C. and at a pressure below 700 bar, below 500 bar or below 100 bar.

Useful polymers in the cement composition can be derived from a perfluoro vinyl monomer. Additionally, the polymer can be derived from at least one mono-vinyl monomer and at least one di-vinyl monomer. The mono-vinyl monomer can be selected from the group consisting of: alkyl acrylates, alkyl methacrylates, cyclohexyl acrylates, cyclohexyl methacrylates, aryl acrylates, aryl methacrylates, aminoalkyl acrylates, aminoalkyl methacrylates, perfluoroalkyl acrylates, perfluoroalkyl methacrylates, alkyl vinyl ethers, perfluoroalkyl vinyl ethers, styrene, acrylonitrile, 2-vinyl pyridine, 4-vinyl pyridine, acrylic acid, methacrylic acid, and vinyl acetate. The di-vinyl monomer can be selected from the group consisting of: alkane diol diacrylates, alkane diol dimethacrylates, alkene glycol diacrylates, alkene glycol dimethacrylates, alkane diol divinyl ethers, alkene glycol divinylethers, divinylbenzene, allyl methacrylate, and allyl acrylate. More specifically, the carbon dioxide swellable polymer can be a fluorinated acrylate polymer produced from 1H,1H,2H,2H-Perfluorooctyl acrylate and ethylene dimethacrylate monomers. Other types of vinyl monomers may be used to the extent that the resulting polymer is still swellable, as defined above.

The amount of polymer can be included in the cement composition in an amount sufficient to seal cracks that may form from physical and thermal stresses and chemical attack in the set or cured cement composition. That is, the polymer should be present in the set cement composition such that exposure to carbon dioxide, hydrogen sulfide, gaseous hydrocarbons, carbonic acid, or hydrochloric acid will cause it to swell sufficiently to seal cracks or holes that have been introduced into the set or cured cement. Typically such cracks or holes are introduce by physical stresses but could be caused by other events. By way of example, the polymer can be present in the cement composition in an amount in the range of from about 0.1% to about 50% by weight of the cement on a dry basis (“bwoc”) (e.g., 0.5%, 1%, 5% bwoc, 10% bwoc, 15% bwoc, 20% bwoc, etc.). In certain embodiments, the polymer can be present in the cement composition in an amount in the range of from about 2% to about 40% bwoc, may be present in the range of 5% to 30% bwoc and can be present in the range of from 10% to 25% bwoc.

The water used in embodiments of the cement compositions of the present invention may be freshwater or saltwater (e.g., water containing one or more salts dissolved therein, seawater, brines, saturated saltwater, etc.). In general, the water may be present in an amount sufficient to form a pumpable slurry. By way of example, the water may be present in the cement compositions in an amount in the range of from about 20% to about 200% bwoc. In certain embodiments, the water may be present in an amount in the range of from about 25% to about 90% bwoc.

Other additives suitable for use in subterranean cementing operations also may be added to embodiments of the cement compositions, in accordance with embodiments of the present invention. Examples of such additives include, but are not limited to, strength-retrogression additives, set accelerators, set retarders, weighting agents, lightweight additives, gas-generating additives, mechanical property enhancing additives, lost-circulation materials, filtration-control additives, dispersants, a fluid loss control additive, defoaming agents, foaming agents, thixotropic additives, and combinations thereof. By way of example, the cement composition may be a foamed cement composition further comprising a foaming agent and a gas. Specific examples of these, and other, additives include crystalline silica, amorphous silica, fumed silica, salts, fibers, hydratable clays, calcined shale, vitrified shale, microspheres, fly ash, slag, diatomaceous earth, metakaolin, pumice rice husk ash, natural pozzolan, zeolite, cement kiln dust, lime, elastomers, resins, latex, combinations thereof, and the like. A person having ordinary skill in the art, with the benefit of this disclosure, will readily be able to determine the type and amount of additive useful for a particular application and desired result.

As will be appreciated by those of ordinary skill in the art, embodiments of the cement compositions of the present invention may be used in a variety of subterranean applications, including primary and remedial cementing. For example, a cement slurry composition comprising cement, a polymer, and water may be introduced into a subterranean formation and allowed to set or cure therein. In certain embodiments, for example, the cement slurry composition may be introduced into a space between a subterranean formation and a pipe string located in the subterranean formation. Embodiments may further comprise running the pipe string into a wellbore penetrating the subterranean formation. The cement slurry composition may be allowed to set or cure to form a hardened mass in the space between the subterranean formation and the pipe string. In addition, a cement composition may be used, for example, in squeeze-cementing operations or in the placement of cement plugs. Embodiments of the present invention further may comprise producing one or more hydrocarbons (e.g., oil, gas, etc.) from a well bore penetrating the subterranean formation.

### EXAMPLES

The following examples further illustrate the invention. Examples 1-4 illustrate polymer synthesis, Examples 5-7 illustrate the swelling of the resultant polymers and Examples 8 and 9 illustrate the use of one of the resultant polymers in a cement composition.

### Example 1

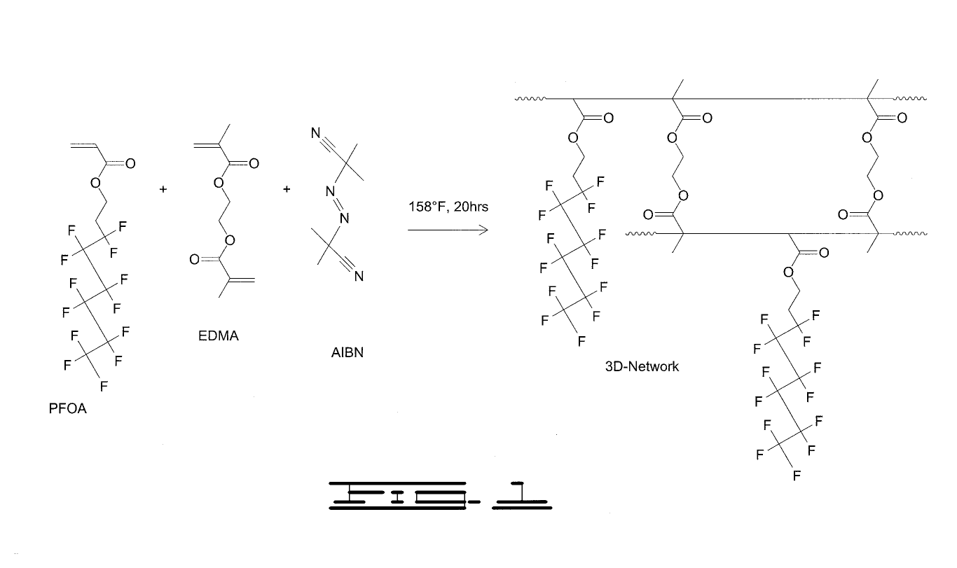

A polymer comprising 1H,1H,2H,2H-Perfluorooctyl acrylate (PFOA) monomer and ethylene dimethacrylate (EDMA) monomer was prepared as follows. PFOA (98 mole-%) and EDMA (2 mole-%) were mixed together in a glass tube and then azobisisobutyronitrile (AIBN) was dissolved in the mixture in an amount of 1 mole-% based on the total moles of PFOA and EDMA. AIBN was added as a free radical initiator. The mixture was then purged with N₂ for 15 minutes and then sealed. The reaction was carried out at 158° F. (70° C.) for 20 hours. The resulting polymer was washed with methanol repeatedly and then dried at 50° C. for 24 hours. A schematic representation of this polymer synthesis is shown in FIG. 1.

### Example 2

A polymer comprising 1H,1H,2H,2H-Perfluorooctyl acrylate (PFOA) monomer, dimethylamino ethyl methacrylate (DMAEMA) monomer and ethylene dimethacrylate (EDMA) monomer was prepared as follows. PFOA (68 mole-%), DMAEMA (30 mole-%) and EDMA (2 mole-%) were mixed together in a glass tube and then azobisisobutyronitrile (AIBN) was dissolved in the mixture in an amount of 1 mole-% based on the total moles of PFOA, DMAEMA and EDMA. AIBN was added as a free radical initiator. The mixture was then purged with N₂ for 15 minutes and then sealed. The reaction was carried out at 158° F. (70° C.) for 20 hours. The resulting polymer was washed with methanol repeatedly and then dried at 50° C. for 24 hours.

### Example 3

A polymer comprising 1H,1H,2H,2H-Perfluorooctyl acrylate (PFOA) monomer, methyl methacrylate (MMA) monomer and ethylene dimethacrylate (EDMA) monomer was prepared as follows. PFOA (70 mole-%), MMA (28 mole-%) and EDMA (2 mole-%) were mixed together in a glass tube and then azobisisobutyronitrile (AIBN) was dissolved in the mixture in an amount of 1 mole-% based on the total moles of PFOA, MMA and EDMA. AIBN was added as a free radical initiator. The mixture was then purged with N₂ for 15 minutes and then sealed. The reaction was carried out at 158° F. (70° C.) for 20 hours. The resulting polymer was washed with methanol repeatedly and then dried at 50° C. for 24 hours.

### Example 4

A polymer comprising 1H,1H,2H,2H-Perfluorooctyl acrylate (PFOA) monomer, dimethylamino ethyl methacrylate (DMAEMA) monomer, methyl methacrylate (MMA) monomer and ethylene dimethacrylate (EDMA) monomer was prepared as follows. PFOA (38 mole-%), DMAEMA (40 mole-%), MMA (20 mole-%) and EDMA (2 mole-%) were mixed together in a glass tube and then azobisisobutyronitrile (AIBN) was dissolved in the mixture in an amount of 1 mole-% based on the total moles of PFOA, DMAEMA, MMA and EDMA. AIBN was added as a free radical initiator. The mixture was then purged with N₂ for 15 minutes and then sealed. The reaction was carried out at 158° F. (70° C.) for 20 hours. The resulting polymer was washed with methanol repeatedly and then dried at 50° C. for 24 hours.

### Example 5

The swelling of the polymer, produced in accordance with Example 1, in the presence of CO₂ was demonstrated. The polymer was placed in a measuring cylinder and then placed in a see-through autoclave. The temperature in the autoclave was 75° F. (24° C.). After removing the air, CO₂ gas was applied and maintained at 700 psi (about 4826 KPa). The swelling of polymer was observed within five minutes in the measuring cylinder. The polymer swelled noticeably. When the polymer was removed from the CO₂ environment, it returned to its original volume slowly (de-swelling).

### Example 6

The swelling of the polymer, produced in accordance with Example 2, in the presence of CO₂ was demonstrated. The polymer was placed in a measuring cylinder and then placed in a see-through autoclave. The polymer level in cylinder was about 22 ml. The temperature in the autoclave was 75° F. (24° C.). After removing the air, CO₂ gas was applied and maintained at 700 psi (about 4826 KPa). The swelling of polymer was observed within five minutes in the measuring cylinder. The polymer swelled noticeably to about 25 ml in the cylinder.

### Example 7

The swelling of the polymer, produced in accordance with Example 2, in the presence of carbonic acid was demonstrated. The polymer was placed in a measuring cylinder which contained deionized water in such a way that the polymer was completely immersed. The polymer did not swell in deionized water and its level in the measuring cylinder was about 19 ml. The measuring cylinder was placed in a see-through autoclave and then CO₂ gas was applied and maintained at 700 psi (about 4828 KPa). The temperature in the autoclave was 75° F. (24° C.). Dissolution of CO₂ gas in deionized water led to in-situ generation of carbonic acid. The swelling of polymer was observed within 30 minutes in the measuring cylinder. The polymer swelled noticeably to about 28 ml in the cylinder.

### Example 8

In order to investigate the swelling of polymer in set cement, a slurry was prepared incorporating a polymer synthesized in accordance with Example 1. The composition of the slurry was as follows: Class G cement (100% by weight of cement); polymer (25% by weight of cement), a free-water cement control additive sold under the trademark FWCA by Halliburton Energy Services, Inc. (0.1% by weight of cement); a defoamer sold under the trademark D-Air 3000 by Halliburton Energy Services, Inc. (0.05 gal/sack based on a 94 lbs. sack of cement or about 4.4 ml/kg), and water (51.59% by weight of the cement). The resultant slurry had density of 14.8 pounds per gallon (about 1773.4 kg/m³. The slurry was cured at 140° F. (60° C.) for 48 hours under atmospheric pressure. The diameter and length of the resulting cured cylinder was 1 and 2 inches (2.54 cm and 5.08 cm), respectively. The diameter of the cement cylinder was reduced to about 0.8 inch (about 2 cm) by machining, so that it would be accommodated within the measuring cylinder even after swelling The measuring cylinder containing the cured cement was placed in a see-through autoclave. CO₂ was applied and maintained at 700 psi (4826 KPa) for a period of 4 hours at 75° F. (about 24° C.). The set cement expanded and formed cracks due to swelling of the polymer.

### Example 9

The ability of the polymer, synthesized in accordance to Example 1, to plug channels in a cement column was studied as follows. A cement slurry was prepared as described in Example 3. The slurry was placed in a fluid loss control analysis cell and then cured at 140° F. (60° C.) for 48 hours under atmospheric pressure. The sieve was removed and then the curried cement was drilled at the center to create a channel The diameter of the channel was about 1 mm. The cell was closed with top and bottom lids and then CO₂ was applied over a period of 4 hours at 75° F. (about 24° C.). After opening the lids, it was observed that the channel was plugged as a result of polymer swelling. This result showed that the synthesized polymer can be used to plug channels in the cement sheath to control gas and/or fluid migration.

In furtherance of the above description, several embodiments will now be described. In one embodiment, there is provided a settable cement composition comprising hydraulic cement and a polymer derived from a perfluoro vinyl monomer. The polymer can be further derived from at least one mono-vinyl monomer and at least one di-vinyl monomer. The mono-vinyl monomer can be selected from the group consisting of: alkyl acrylates, alkyl methacrylates, cyclohexyl acrylates, cyclohexyl methacrylates, aryl acrylates, aryl methacrylates, aminoalkyl acrylates, aminoalkyl methacrylates, perfluoroalkyl acrylates, perfluoroalkyl methacrylates, alkyl vinyl ethers, perfluoroalkyl vinyl ethers, styrene, acrylonitrile, 2-vinyl pyridine, 4-vinyl pyridine, acrylic acid, methacrylic acid, and vinyl acetate. The di-vinyl monomer can be selected from the group consisting of: alkane diol diacrylates, alkane diol dimethacrylates, alkene glycol diacrylates, alkene glycol dimethacrylates, alkane diol divinyl ethers, alkene glycol divinylethers, divinylbenzene, allyl methacrylate, and allyl acrylate.

In another embodiment, there is provided a settable cement composition comprising a carbon dioxide swellable polymer, a hydraulic cement, and water. Generally, the carbon dioxide swellable polymer swells in carbon dioxide at a temperature below 250° C. and at a pressure below 1000 bar, and can swell at temperatures below 200° C. and at a pressure below 700 bar or below 150° C. and at a pressure below 500 bar. More typically, the carbon dioxide swellable polymer can swell in carbon dioxide at a temperature below 100° C. and at a pressure below 100 bar. The carbon dioxide swellable polymer can be derived from a perfluoro vinyl monomer and the polymer can be derived from at least one mono-vinyl monomer and at least one di-vinyl monomer. The mono-vinyl monomer can be selected from the group consisting of: alkyl acrylates, alkyl methacrylates, cyclohexyl acrylates, cyclohexyl methacrylates, aryl acrylates, aryl methacrylates, aminoalkyl acrylates, aminoalkyl methacrylates, perfluoroalkyl acrylates, perfluoroalkyl methacrylates, alkyl vinyl ethers, perfluoroalkyl vinyl ethers, styrene, acrylonitrile, 2-vinyl pyridine, 4-vinyl pyridine, acrylic acid, methacrylic acid, and vinyl acetate. The di-vinyl monomer is selected from the group consisting of: alkane diol diacrylates, alkane diol dimethacrylates, alkene glycol diacrylates, alkene glycol dimethacrylates, alkane diol divinyl ethers, alkene glycol divinylethers, divinylbenzene, allyl methacrylate, and allyl acrylate.

More specifically, the carbon dioxide swellable polymer can be a fluorinated acrylate polymer produced from 1H,1H,2H,2H-Perfluorooctyl acrylate and ethylene dimethacrylate monomers. Also, carbon dioxide swellable polymer can be present in an amount in a range from about 5% to about 50% by weight of the cement on a dry basis.

In still another embodiment, there is provided a method of cementing comprising:
providing hydraulic cement;
providing a carbon dioxide swellable polymer;
preparing a cement slurry composition comprising the cement, the carbon dioxide swellable polymer and water,
introducing the cement slurry composition into a subterranean formation; and
allowing the cement slurry composition to set in the subterranean formation to form a hardened cement that prevents migration of gases and fluids.

In the above method, the carbon dioxide swellable polymer can be present in an amount in a range from about 0.1% bwoc to about 50% bwoc. Also, the cement composition can have a density of about 4 pounds per gallon to about 20 pounds per gallon. The hydraulic cement can comprise at least one cement selected from the group consisting of Portland cement, pozzolan cement, gypsum cement, high-alumina-content cement, slag cement, silica cement, and any combination thereof.

The method can further comprise allowing the cement composition to set in a space between a pipe string and the subterranean formation. Also, the method can comprise running the pipe string into a well bore penetrating the subterranean formation. Additionally, the carbon dioxide swellable polymer can be present in the cement composition in an amount sufficient to seal cracks in the set cement composition.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” “having,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A settable cement composition comprising:
a hydraulic cement, and
a polymer derived from a perfluoro vinyl monomer.

2. The composition of claim 1 wherein said polymer is derived from at least one mono-vinyl monomer and at least one di-vinyl monomer.

3. The composition of claim 2 wherein said mono-vinyl monomer is selected from the group consisting of: alkyl acrylates, alkyl methacrylates, cyclohexyl acrylates, cyclohexyl methacrylates, aryl acrylates, aryl methacrylates, aminoalkyl acrylates, aminoalkyl methacrylates, perfluoroalkyl acrylates, perfluoroalkyl methacrylates, alkyl vinyl ethers, perfluoroalkyl vinyl ethers, styrene, acrylonitrile, 2-vinyl pyridine, 4-vinyl pyridine, acrylic acid, methacrylic acid, and vinyl acetate.

4. The composition of claim 2 wherein said di-vinyl monomer is selected from the group consisting of: alkane diol diacrylates, alkane diol dimethacrylates, alkene glycol diacrylates, alkene glycol dimethacrylates, alkane diol divinyl ethers, alkene glycol divinylethers, divinylbenzene, allyl methacrylate, and allyl acrylate.

5. A settable cement composition comprising:
a carbon dioxide swellable polymer;
a hydraulic cement; and
water.

6. The composition of claim 5 wherein said carbon dioxide swellable polymer swells in carbon dioxide at a temperature below 250° C. and at a pressure below 1000 bar.

7. The composition of claim 5 wherein said carbon dioxide swellable polymer swells in carbon dioxide at a temperature below 100° C. and at a pressure below 100 bar.

8. The composition of claim 5 wherein said carbon dioxide swellable polymer is derived from a perfluoro vinyl monomer.

9. The composition of claim 8 wherein said polymer is derived from at least one mono-vinyl monomer and at least one di-vinyl monomer.

10. The composition of claim 9 wherein said mono-vinyl monomer is selected from the group consisting of: alkyl acrylates, alkyl methacrylates, cyclohexyl acrylates, cyclohexyl methacrylates, aryl acrylates, aryl methacrylates, aminoalkyl acrylates, aminoalkyl methacrylates, perfluoroalkyl acrylates, perfluoroalkyl methacrylates, alkyl vinyl ethers, perfluoroalkyl vinyl ethers, styrene, acrylonitrile, 2-vinyl pyridine, 4-vinyl pyridine, acrylic acid, methacrylic acid, and vinyl acetate.

11. The composition of claim 10 wherein said di-vinyl monomer is selected from the group consisting of: alkane diol diacrylates, alkane diol dimethacrylates, alkene glycol diacrylates, alkene glycol dimethacrylates, alkane diol divinyl ethers, alkene glycol divinylethers, divinylbenzene, allyl methacrylate, and allyl acrylate.

12. The composition of claim 5 wherein said carbon dioxide swellable polymer is a fluorinated acrylate polymer.

13. The composition of claim 12 wherein said carbon dioxide swellable polymer is produced from 1H,1H,2H,2H-Perfluorooctyl acrylate and ethylene dimethacrylate monomers.

14. The composition of claim 1 wherein said carbon dioxide swellable polymer is present in an amount in a range from about 5% to about 50% by weight of said hydraulic cement on a dry basis.

15. A method of cementing comprising:
providing a hydraulic cement;
providing a carbon dioxide swellable polymer;
preparing a cement slurry composition comprising said hydraulic cement, said carbon dioxide swellable polymer and water,
introducing said cement slurry composition into a subterranean formation; and
allowing said cement slurry composition to set in said subterranean formation to form a hardened cement that prevents migration of gases and fluids.

16. The method of claim 15 wherein said carbon dioxide swellable polymer is present in an amount in a range from about 5% to about 50% by weight of said hydraulic cement on a dry basis.

17. The composition of claim 15 wherein said carbon dioxide swellable polymer is derived from a perfluoro vinyl monomer.

18. The composition of claim 17 wherein said polymer is derived from at least one mono-vinyl monomer and at least one di-vinyl monomer.

19. The composition of claim 18 wherein:
said mono-vinyl monomer is selected from the group consisting of: alkyl acrylates, alkyl methacrylates, cyclohexyl acrylates, cyclohexyl methacrylates, aryl acrylates, aryl methacrylates, aminoalkyl acrylates, aminoalkyl methacrylates, perfluoroalkyl acrylates, perfluoroalkyl methacrylates, alkyl vinyl ethers, perfluoroalkyl vinyl ethers, styrene, acrylonitrile, 2-vinyl pyridine, 4-vinyl pyridine, acrylic acid, methacrylic acid, and vinyl acetate; and
said di-vinyl monomer is selected from the group consisting of: alkane diol diacrylates, alkane diol dimethacrylates, alkene glycol diacrylates, alkene glycol dimethacrylates, alkane diol divinyl ethers, alkene glycol divinylethers, divinylbenzene, allyl methacrylate, and allyl acrylate.

20. The composition of claim 15 wherein said carbon dioxide swellable polymer is produced from 1H,1H,2H,2H-Perfluorooctyl acrylate and ethylene dimethacrylate monomers.
